(19) United States
(12) Patent Application Publication
(10) Pub. No.: US 2022/0217433 A1
(43) Pub. Date: Jul. 7, 2022

(54) METHODS, DEVICES, AND SYSTEMS FOR PROVIDING A SHARED PLAYLIST

(71) Applicant: Aux, Inc., Chapel Hill, NC (US)

(72) Inventors: Eugene Krugly, Chapel Hill, NC (US); William Webster Cahan, Chapel Hill, NC (US); Andrew David Kabealo, Advance, NC (US)

(21) Appl. No.: 17/567,619

(22) Filed: Jan. 3, 2022

Related U.S. Application Data
(60) Provisional application No. 63/133,443, filed on Jan. 4, 2021.

(51) Int. Cl. H04N 21/262; H04N 21/25; H04N 21/258; H04N 21/443; H04N 21/482

(52) U.S. Cl. CPC H04N 21/26258; H04N 21/252; H04N 21/4825; H04N 21/4431; H04N 21/25891

(57) ABSTRACT

Disclosed herein are methods, systems, and devices for providing a shared playlist. According to one embodiment, a method is implemented on one or more servers. The method includes receiving a plurality of identifiers associated with a plurality of client devices, receiving a plurality of listening profiles associated with the identifiers, generating the shared playlist based on the plurality of listening profiles, and transmitting the shared playlist to the plurality of client devices. Additionally, the shared playlist is executed on the plurality of client devices in a synchronized via one or more application programing interfaces (APIs) provided by one or more third party audio streaming services.

### PRIORITY CLAIM

This application claims priority to U.S. Provisional Patent Application Ser. No. 63/133,443 filed Jan. 4, 2021, entitled “METHODS, DEVICES, AND SYSTEMS FOR PROVIDING A SHARED PLAYLIST.” The disclosure of the aforementioned application is incorporated herein by reference in its entirety.

### TECHNICAL FIELD

The present invention relates to a server application, a mobile device application, and a client/server infrastructure; and more specifically to methods, devices, and systems for providing a shared playlist to a plurality of users.

### BACKGROUND

Audio streaming (e.g. music streaming) provide on-demand content to client devices (mobile and fixed devices) of end-users and continues to grow in popularity over keeping audio content stored on these client devices. Subscription based services were estimated to be over 60 million in the United States in 2019 and have grown over 500% in the past years. The industry is expected to be worth over $120 billion by 2025. Additionally, curated playlists have become popular with users of music streaming services.

Currently, music streaming services offer little to no group listening features. Additionally, no music streaming services offer any group playlist curation features. Further no cross platform collaboration is provided by these streaming services.

Behavioral science suggests that social interactions are heavily connected with group music. Accordingly, a need exists to provide shared playlists among users (i.e. collaborative listening experiences).

### SUMMARY

The presently disclosed subject matter is directed toward methods, devices, and systems for solving the problem of providing a shared playlist. According to one embodiment, a method is implemented on one or more servers. The method includes receiving a plurality of identifiers associated with a plurality of client devices, receiving a plurality of listening profiles associated with the identifiers, generating the shared playlist based on the plurality of listening profiles, and transmitting the shared playlist to the plurality of client devices.

In some embodiments, the shared playlist may be executed on the plurality of client devices. In certain embodiments, the shared playlist may be executed on the plurality of client devices in a synchronized manner.

In some embodiments, the shared playlist may be executed on the plurality of client devices via one or more application programing interfaces (APIs) provided by one or more third party audio streaming services. In certain embodiments, the one or more third party audio streaming services may include Spotify®, Apple Music®, and Soundcloud®, and/or the like.

In some embodiments, the plurality of listening profiles may be based on a plurality of requests to one or more third party audio streaming services. In certain embodiments, the plurality of requests may be made via one or more APIs provided by the one or more third party audio streaming services. In further embodiments, the one or more third party audio streaming services may also include Spotify®, Apple Music®, and Soundcloud®, and/or the like.

In some embodiments, the plurality of identifiers may be received from a first client device of the plurality of client devices. In certain embodiments, the plurality of identifiers may be based on one or more selections made by a user on a graphical user interface (GUI) of the first client device. In further embodiments, the one or more selections may be based on approximate locations of at least a portion of the plurality of client devices displayed by the GUI.

In some embodiments, the GUI may be provided by an application specific program installed on the first client device. In certain embodiments, the application specific program may be an iOS® app, an Android® OS app, or the like. In other embodiments, the application specific program may be a Windows® app, a macOS® app, a Linux® app, or the like.

In some embodiments, generating the shared playlist may be further based on machine learning. Generating the shared playlist may also be further based on at least one location associated with a plurality of client devices. In further embodiments, generating the shared playlist may be based on a plurality of locations associated with the plurality of client devices. In still further embodiments, generating the shared playlist may be based on a calendar date, a time of day, a current event, and/or the like.

In some embodiments, the plurality of listening profiles may be based on a plurality of requests via one or more APIs provided by at least three mutually exclusive third party audio streaming services, and the shared playlist may be executed on the plurality of client devices via one or more APIs provided by the at least three mutually exclusive third party audio streaming services.

In some embodiments, the plurality of listening profiles may include a plurality of listening histories, a plurality of listening profiles, and/or the like associated with a plurality of users associated with at least a portion of the plurality of client devices. In certain embodiments, the plurality of listening profiles may include a plurality of preferred genres, a plurality of favorite artists, a plurality of favorite musical interests, and/or a plurality of favorite songs associated with a plurality of users associated with at least a portion of the plurality of client devices.

In some embodiments, the plurality of listening profiles may include a plurality of purchasing histories associated with a plurality of users associated with at least a portion of the plurality of client devices. In certain embodiments, the plurality of purchasing histories may include music purchases.

In some embodiments, the at least one server of the one or more servers may be a virtual server. In certain embodiments, the virtual server may be hosted in a cloud computing environment.

According to another embodiment, a server includes a memory, a database, and a processor configured for providing a method of generating a shared playlist. The method includes receiving a plurality of identifiers associated with a plurality of client devices, receiving a plurality of listening profiles associated with the identifiers, generating the shared playlist based on the plurality of listening profiles, and transmitting the shared playlist to the plurality of client devices.

According to another embodiment, a non-transitory computer readable medium includes a plurality of machine-readable instructions. The machine-readable instructions when executed by one or more processors of a server are adapted to cause the server to perform a method of generating a shared playlist. The method includes receiving a plurality of identifiers associated with a plurality of client devices, receiving a plurality of listening profiles associated with the identifiers, generating the shared playlist based on the plurality of listening profiles, and transmitting the shared playlist to the plurality of client devices.

According to another embodiment, a method is implemented on a client device. The method includes (1) upon selection by a user of the client device, transmitting a plurality of identifiers associated with a plurality of client devices to a server; (2) receiving a shared playlist from the server; and (3) executing at least a portion of the shared playlist. The shared playlist may be generated based on a plurality of listening profiles associated with the plurality of client devices and machine learning, the shared playlist may be received by the plurality of client devices, and the shared playlist may be executed by at least a portion of the plurality of client devices.

According to another embodiment, a client device includes a memory and a processor. The processor is configured to perform a method. The method includes (1) upon selection by a user of the client device, transmitting a plurality of identifiers associated with a plurality of client devices to a server; (2) receiving a shared playlist from the server; and (3) executing at least a portion of the shared playlist. The shared playlist may be generated based on a plurality of listening profiles associated with the plurality of client devices and machine learning, the shared playlist may be received by the plurality of client devices, and the shared playlist may be executed by at least a portion of the plurality of client devices.

According to another embodiment, a non-transitory computer readable medium includes a plurality of machine-readable instructions. The machine-readable instructions when executed by one or more processors of a client device are adapted to cause the client device to perform a method. The method includes (1) upon selection by a user of the client device, transmitting a plurality of identifiers associated with a plurality of client devices to a server; (2) receiving a shared playlist from the server; and (3) executing at least a portion of the shared playlist. The shared playlist may be generated based on a plurality of listening profiles associated with the plurality of client devices and machine learning, the shared playlist may be received by the plurality of client devices, and the shared playlist may be executed by at least a portion of the plurality of client devices.

### BRIEF DESCRIPTION OF THE DRAWINGS

The present embodiments are illustrated by way of example and are not intended to be limited by the figures of the accompanying drawings. In the drawings:

FIG. 1 depicts a flow chart illustrating a shared playlist user experience in accordance with embodiments of the present disclosure.

FIG. 2 depicts another flow chart illustrating a shared playlist creation method in accordance with embodiments of the present disclosure.

FIG. 3 depicts another flow chart illustrating a proximity sensing and location data display in accordance with embodiments of the present disclosure.

FIG. 4 depicts a system implemented as a client/server architecture that includes a server application hosted on a server in accordance with embodiments of the present disclosure.

FIG. 5 depicts an example block diagram of the server of FIG. 4 in accordance with embodiments of the present disclosure.

FIG. 6 depicts illustrates an example block diagram of a mobile device of FIG. 4 in accordance with embodiments of the present disclosure.

FIG. 7 depicts a graphical user interface (GUI) implemented on a mobile device of the system of FIG. 4 in accordance with embodiments of the present disclosure.

FIG. 8 depicts another GUI implemented on a mobile device of the system of FIG. 4 GUI in accordance with embodiments of the present disclosure.

FIG. 9 depicts another GUI implemented on a mobile device of the system of FIG. 4 GUI in accordance with embodiments of the present disclosure.

FIG. 10 depicts another flow chart illustrating a method implemented on a server for providing a shared playlist user experience in accordance with embodiments of the present disclosure.

FIG. 11 depicts another flow chart illustrating a method implemented on a mobile device for providing a shared playlist user experience in accordance with embodiments of the present disclosure.

FIG. 12 depicts a diagram illustrating social curation using preferences within peer networks to suggest media for a shared playlist in accordance with embodiments of the present disclosure.

FIG. 13 depicts a diagram illustrating using a friends list of a user in determining content for a shared playlist in accordance with embodiments of the present disclosure.

FIG. 14 depicts a diagram illustrating using subgroups in determining content for a shared playlist in accordance with embodiments of the present disclosure.

FIG. 15 depicts a diagram illustrating a business environment implementation of a shared playlist user experience in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The presently disclosed subject matter (i.e. the Aux™ system) is directed toward methods, devices, and systems for solving the problem of providing a shared playlist. Having such a shared playlist solves many problems including (1) the stress of a host being in charge providing music, (2) certain individuals dominating group music choice, (3) businesses that need music but want to better suite their customer/audience. The Aux™ system (via a shared playlist) can tailor environments to users, provide equal representation of all users (i.e. equal user input), and be a preferred choice for businesses that need to provide music. Basically curating environments to people (via a shared playlist) has a much greater effect on individual comfort than curating environments to a generic format.

The Aux™ system is a client server architecture that is cross platform between streaming platforms providing an open application programing interface (API). The Aux™ system may be integrated with Spotify®, Apple Music®, Soundcloud®, and/or the like. The Aux™ system introduces multiplatform collaborative listening using collaborative machine learning curation. Users may easily implement the Aux™ system for any planned event. Even music interaction between two different groups of users may be simplified using the Aux™ system. Additionally small businesses may use live Aux™ playlists to enhance customer comfort. The Aux™ system continues to learn with the near real-time feedback provided by users and groups. Basically with user filtering and artificial intelligence (AI) reconfiguration of playlists, the Aux™ system continues to become more powerful. Via free accounts (using targeted advertising) and subscription based tiers the Aux™ system is self-sustainable.

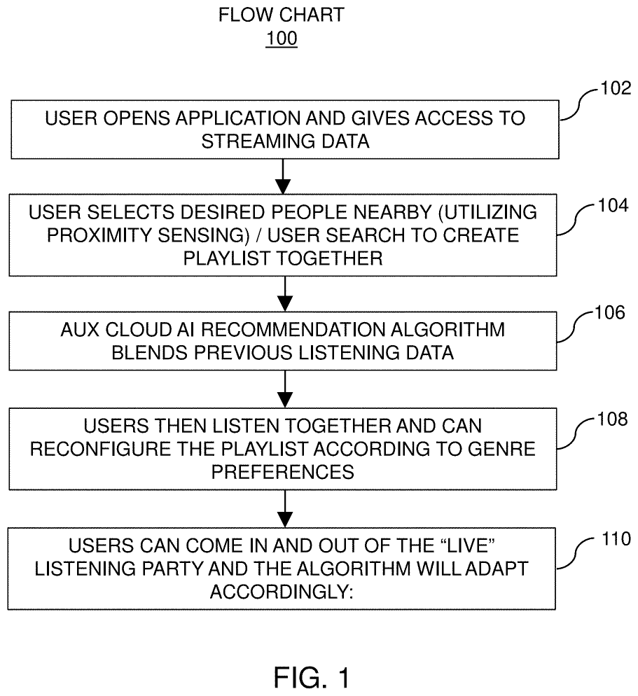

FIG. 1 depicts a flow chart 100 illustrating an Aux™ user experience. In step 102, a user opens an Aux™ client application and gives access to streaming data (e.g. streaming music). In step 104, the user selects other desired users nearby (utilizing proximity sensing) and user search to create playlists together. In step 106, an Aux™ cloud application running on a server uses an AI recommendation algorithm to blend previous listening data of the desired people. In step 108, the users then listen together and can reconfigure the playlist according to genre preferences. In step 110, users may come in and out of the “live” listening party and the Aux™ algorithm will adapt accordingly:

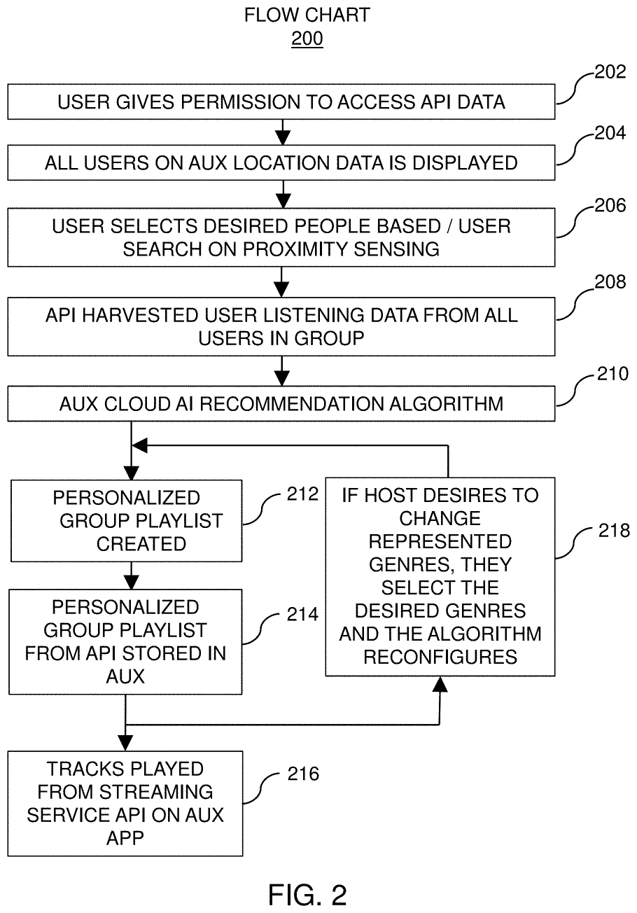

FIG. 2 depicts a flow chart 200 illustrating an Aux™ shared playlist creation. In step 202, a user (i.e. host) gives the Aux™ system (Aux™ client application and Aux™ server application) permission to access API data associated with one or more streaming services and location based services on the user's client device. In step 204, all users within a certain proximity and/or selected profile using the Aux™ system have their location data displayed on the user's client device. In step 206, the user selects the desired Aux™ users after searching. In step 208, the Aux™ system harvests user listening data from all users in the selected group using one or more APIs. In step 210, the Aux™ system initiates an AI recommendation algorithm using the harvested user listening data. In step 212, the Aux™ system creates a personalized group shared playlist and distributes to the selected users' client devices. In step 214, at least a portion of the personalized group playlist is loaded to streaming apps via their respective API and the Aux™ system. In step 216, tracks are then played on the user's devices using the Aux™ client application via the streaming service API. In step 218, if the host desires to change represented genres, they may select the desired genres and the Aux™ AI algorithm reconfigures the shared playlist and updates the shared playlist to the users' client devices.

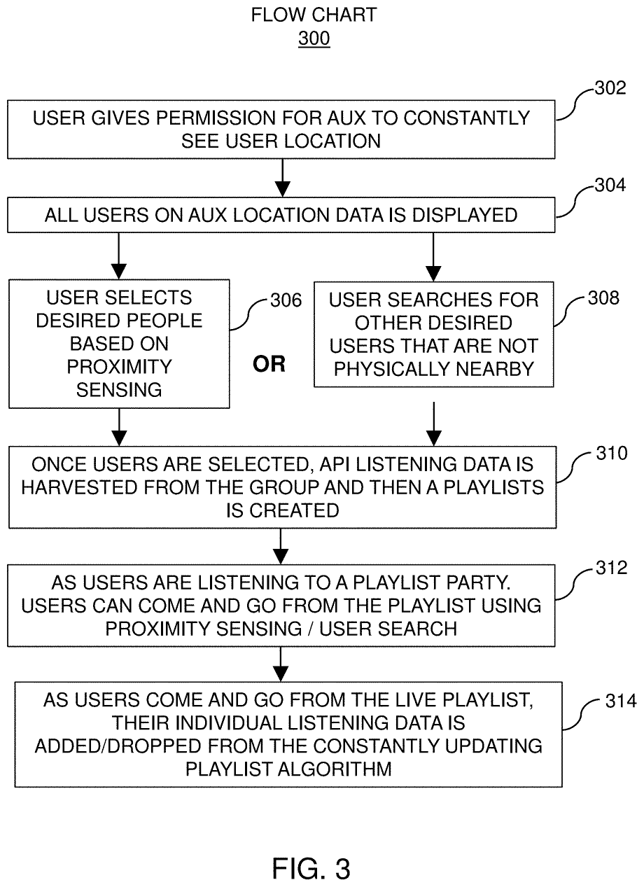

FIG. 3 depicts a flow chart 300 illustrating the Aux™ proximity sensing and location data display. In step 302, users give permission for the Aux™ system to constantly have access to their user location data. In step 304, all Aux™ users have their location data is accessed by the Aux™ system. In step 306, a user (i.e. host) selects desired Aux™ users based on proximity sensing. In step 308, the user (i.e. host) searches for other desired users that are not physically nearby. In step 310, once Aux™ users are selected, API listening data is harvested from the group and then a shared playlist is created by the Aux™ AI algorithm. In step 312, as Aux™ users are listening to a playlist party, Aux™ users may come and go from the playlist using proximity sensing and user search. In step 314, as Aux™ users come and go from the live shared playlist, their individual listening data is added/dropped from the constantly updating playlist Aux™ AI algorithm.

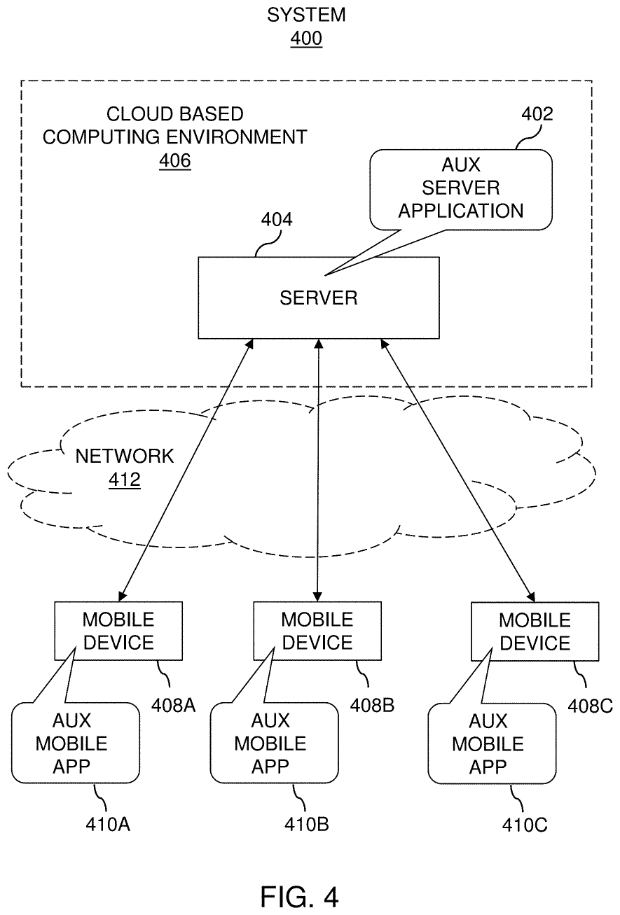

FIG. 4 depicts a system 400 implemented as a client/server architecture that includes an Aux™ server application 402 hosted on a server 404. The server 404 is resident in a cloud based computing environment 406. In other embodiments, the server 404 may be housed at another business center or other type of datacenter. The server 404 communicates with a plurality of mobile devices 408A-C, hosting a plurality of Aux™ mobile apps 410A-C. The Aux™ mobile apps 410A-C may communicate via APIs with one or more streaming services apps (not shown in FIG. 4) resident on the mobile devices 408A-C. Also, the AuxTM server application 402 may communicate via APIs with one or more streaming services server applications (not shown in FIG. 4) associated with the one or more streaming services apps.

The mobile devices 408A-C may be smart phones, tablets, laptops, smart watches, or the like. The server 404 may also communicate with one or more personal computers, smart TVs or other fixed devices hosting an Aux™ based app (not shown in FIG. 4). The Aux™ mobile apps 410A-C communicate with the Aux™ server application 402 over a network 412. The network 412 may be any type or combination of wired, wireless, and/or optical networks. The network 412 may include the Internet. Additionally, the Aux™ server application 402 may communicate using one or more backend APIs to one or more other systems associated with Aux system (e.g. billing systems, advertising systems, etc.) not shown in FIG. 4. The backend APIs may communicate within the cloud based computing environment 406 and/or over the network 412.

The server 404 with the Aux™ server application 402 may perform any of the methods described in the summary, detailed description, and/or the claims. The Aux™ server application 402 transforms the server 404 and mobile devices 408A-C (via the Aux™ mobile apps 410A-C) from a generic computer function into a machine for solving the problem of providing collaborative listening experiences.

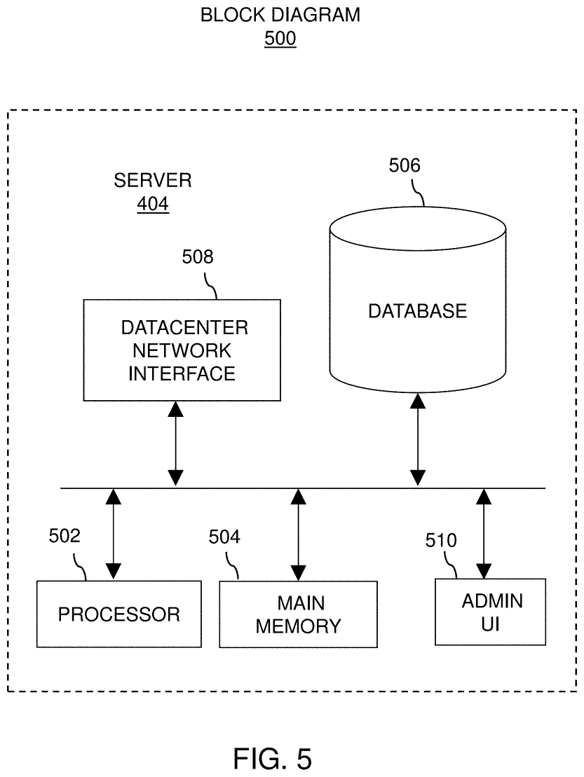

FIG. 5 illustrates an example block diagram 500 of the server 404 of FIG. 4. The server 404 includes at least one processor 502, a main memory 504, a storage memory (e.g. database) 506, a datacenter network interface 508, and an administration user interface (UI) 510. The server 404 may be configured to host an Ubuntu® server or the like. In some embodiments the Ubuntu® server may be distributed over a plurality of hardware servers using hypervisor technology.

The processor 502 may be a multi-core server class processor suitable for hardware virtualization. The processor may support at least a 64-bit architecture and a single instruction multiple data (SIMD) instruction set. The main memory 504 may include a combination of volatile memory (e.g. random access memory) and non-volatile memory (e.g. flash memory). The database 506 may include one or more hard drives. The database 506 may also be configured to store one or more listening profiles associated with users of the Aux system.

The datacenter network interface 508 may provide one or more high-speed communication ports to data center switches, routers, and/or network storage appliances. The datacenter network interface 508 may include high-speed optical Ethernet, InfiniBand (IB), Internet Small Computer System Interface (iSCSI), and/or Fibre Channel interfaces. The administration UI may support local and/or remote configuration of the server 404 by a datacenter administrator.

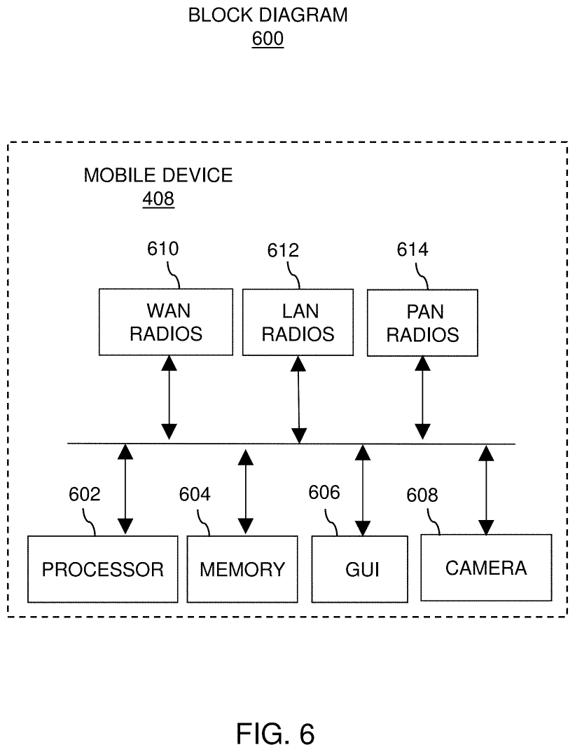

FIG. 6 illustrates a block diagram 600 of the mobile device 408 of FIG. 4. The mobile device 408 may include at least a processor 602, a memory 604, a GUI 606, a camera 608, wide area network (WAN) radios 610, local area network (LAN) radios 612, and personal area network (PAN) radios 614. In some embodiments, the mobile device 408 may be an iPhone® or an iPad®, using iOS® as an operating system (OS). In other embodiments, the mobile device 608 may be an Android® OS device.

In some embodiments, the processor 602 may be a mobile processor such as the Qualcomm® Snapdragon™ mobile processor. The memory 604 may include a combination of volatile memory (e.g. random access memory) and non-volatile memory (e.g. flash memory). The memory 604 may be partially integrated with the processor 602. The GUI 606 may be integrated such as a touchpad display. The WAN radios 610 may include 2G, 3G, 4G, and/or 5G technologies. The LAN radios 612 may include Wi-Fi technologies such as 802.11a, 802.11b/g/n, 802.11ac, and/or 802.11ax circuitry. The PAN radios 614 may include Bluetooth® technologies.

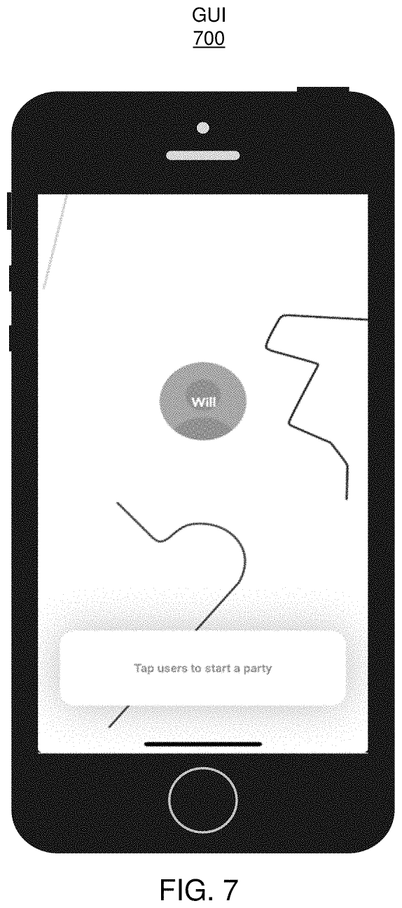

FIG. 7 depicts a GUI 700 on an iPhone® provided by the Aux™ system illustrating easy collaborative listening. The GUI 700 illustrates a selection for a user “Will” to add to generate a shared playlist.

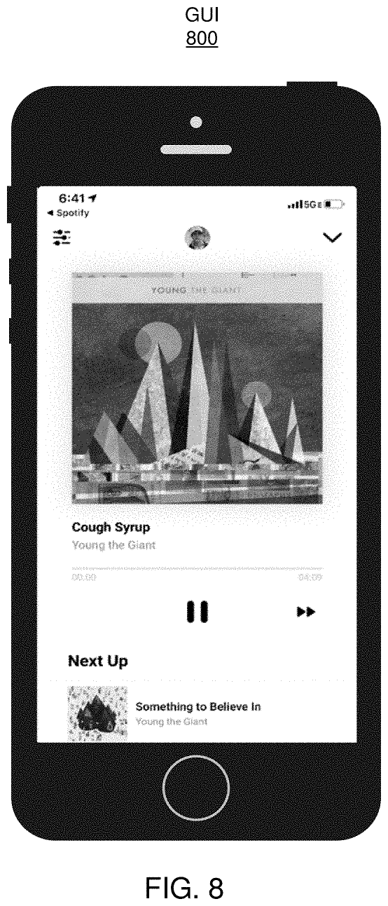

FIG. 8 depicts a GUI 800 on an iPhone® provided by the Aux™ system illustrating live playlist functionality using a Spotify® app. A song called “Cough Syrup” by a group named “Young the Giant” is currently playing. The next song of the shared playlist is shown as “Something to Believe In” also by the group named “Young the Giant.”

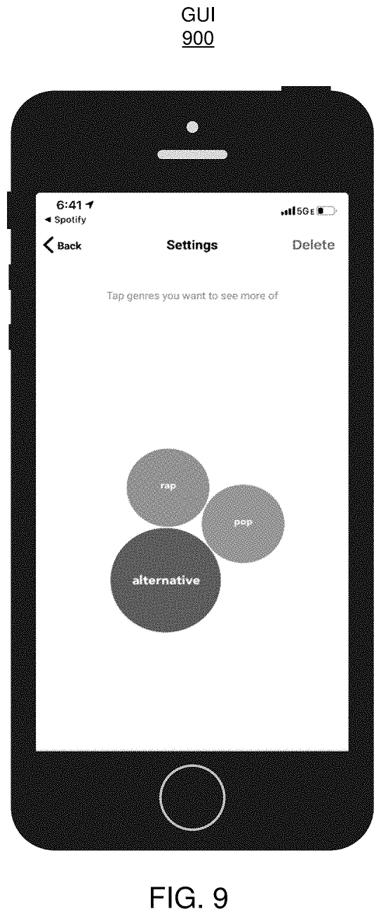

FIG. 9 depicts a GUI 900 on an iPhone® provided by the Aux™ system illustrating user control functionality. The GUI provides settings for changing genres such as rap, pop, and alternative genres.

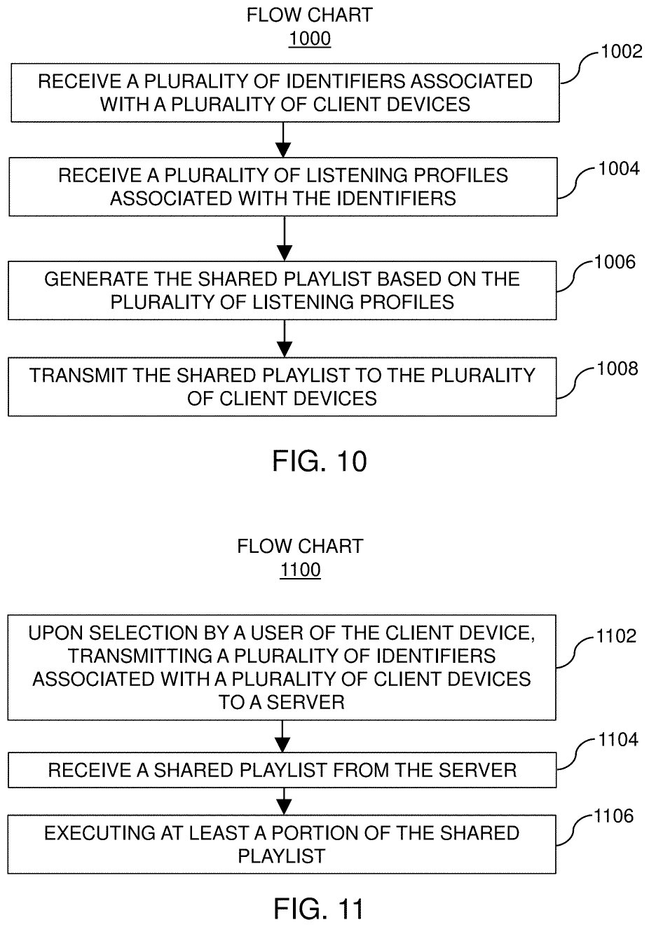

FIG. 10 depicts a flow chart 1000 illustrating a method implemented on a server (e.g. server 404 of FIG. 4) for providing a shared playlist user experience in accordance with embodiments of the present disclosure.

In step 1002, the method includes receiving a plurality of identifiers associated with a plurality of client devices (e.g. mobile devices 408-408C of FIG. 4).

In step 1004, the method further includes receiving a plurality of listening profiles associated with the identifiers.

In step 1006, the method further includes generating a shared playlist based on the plurality of listening profiles.

In step 1008, the method further includes transmitting the shared playlist to the plurality of client devices.

FIG. 11 depicts a flow chart 1100 illustrating a method implemented on a mobile device for providing a shared playlist user experience in association with the method of flowchart 1100 of FIG. 10 in accordance with embodiments of the present disclosure.

In step 1102, the method includes transmitting a plurality of identifiers associated with a plurality of client devices to a server upon selection by a user of the client device.

In step 1104, the method further includes receiving the shared playlist from the server.

In step 1106, the method further includes executing at least a portion of the shared playlist on the mobile device.

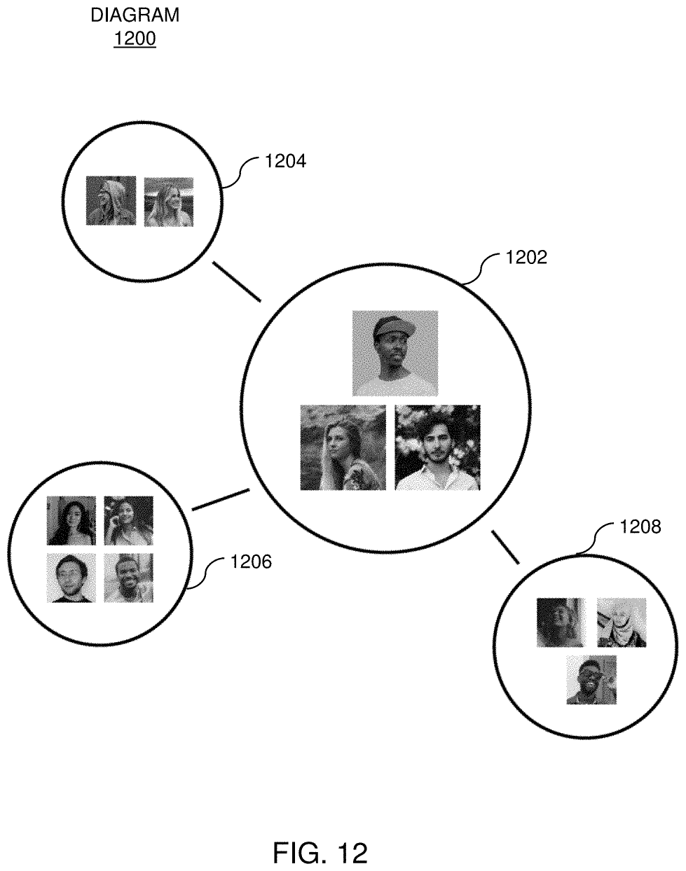

FIG. 12 depicts a diagram 1200 illustrating social curation using preferences within peer networks to suggest media for a shared playlist for a user group 1202 in accordance with embodiments of the present disclosure. By understanding a user and/or a user group as a holistic part of their immediate social networks 1204 through 1208, social curation may be used to generate the shared playlist. The immediate social networks may include one or more Instagram® accounts, one or more YouTube® accounts, one or more Facebook® accounts, one or more Twitter® accounts, one or more TikTok® accounts, one or more Pinterest® accounts, one or more Snapchat® accounts, and/or the like

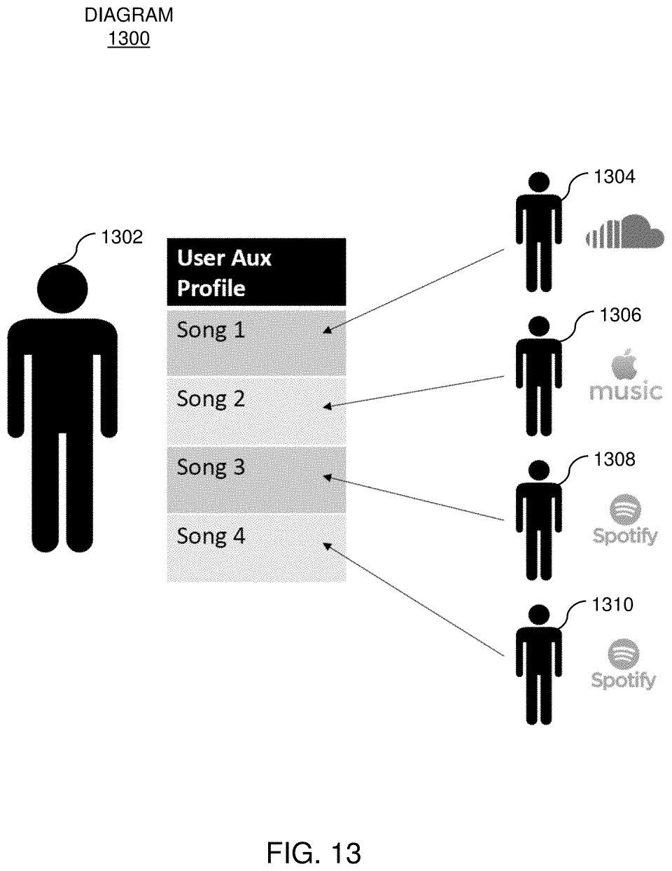

FIG. 13 depicts a diagram 1300 illustrating using a friends list of a user 1302 in determining media content for a shared playlist in accordance with embodiments of the present disclosure. Songs 1-4 may be determined for a user profile using profiles of users 1304-1310. Open APIs may be used from multiple streaming services (e.g. Spotify®, Apple Music®, Soundcloud®, etc.) of the users 1304-1310 in generation of the shared playlist.

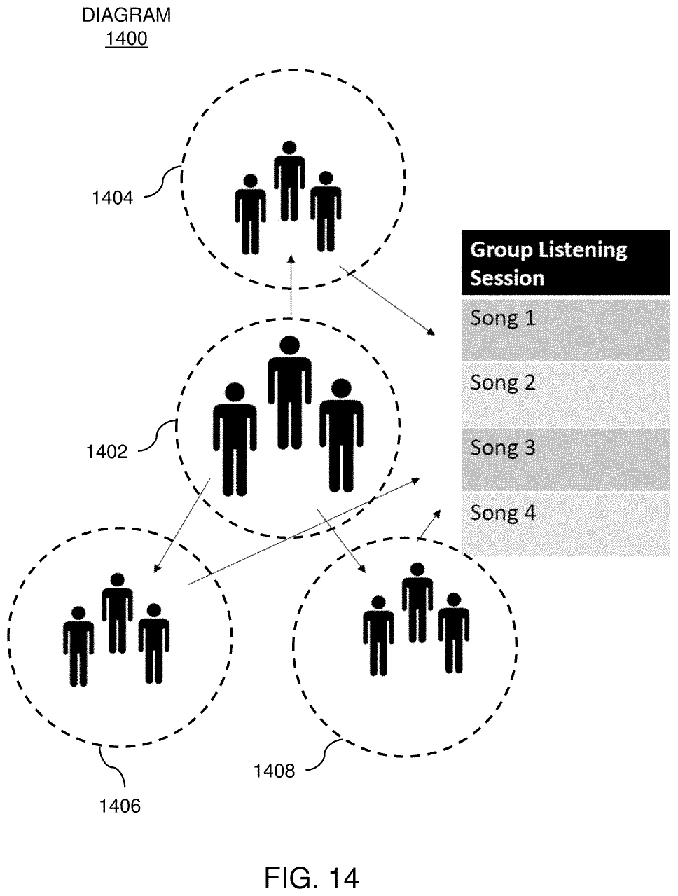

FIG. 14 depicts a diagram 1400 illustrating using subgroups in determining media content for a shared playlist in accordance with embodiments of the present disclosure. The shared playlist provides a group listening session (e.g. songs 1-4) for a user group 1402. The shared playlist may be determined using profiles from subgroups 1404-1408. Using extended profiles of the subgroups 1404-1408 enhances the power of social curation. The shared playlist may be further determined using any of the previously disclosed methods.

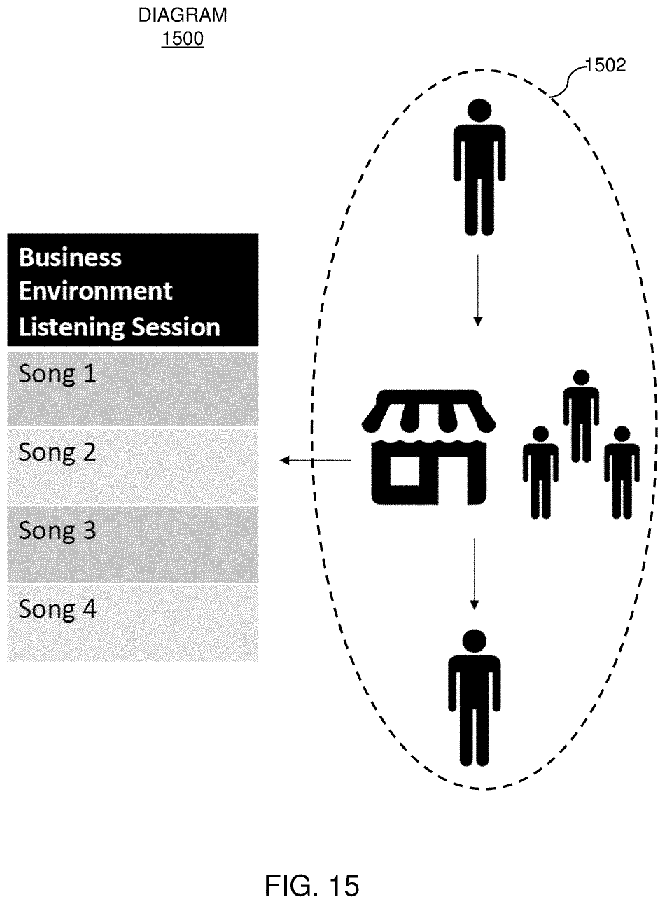

FIG. 15 depicts a diagram 1500 illustrating a business environment implementation of a shared playlist user experience in accordance with embodiments of the present disclosure. Professional networking information may be used to generate one or more shared playlists for a business environment 1502. For example, user professional networking information may be provided by one or more LinkedIn® accounts, one or more Chamber of Commerce accounts, one or more SCORE® accounts, one or more Rotary Club accounts, and/or the like.

Additionally, user technical profession organization information may be used to generate the one or more shared playlists. For example, the user technical profession organization information may be provided by one or more Association for Computing Machinery ACM® accounts, one or more Network Professional Association accounts, one or more CompTIA® accounts, one or more Association for Women in Computing accounts, one or more Association of Information Technology Professionals accounts, one or more National Society of Professional Engineers accounts, one or more American Association of Engineering Societies accounts, one or more Society of Women Engineers accounts, one or more International Engineering Consortium accounts, one or more Electrical and Electronics Engineers (IEEE®) accounts, and/or the like.

The one or more shared playlists may be used to define an intended ambience for the business environment 1502. The employees and/or patrons may be users within the business environment 1502. An algorithm may be used to adjust the shared playlists as users enter and/or leave the business environment 1502. The algorithm may generate the one or more shared playlists as described in any of the previously disclosed methods.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, AngularJS, or the like. The program code may execute entirely on the user's computer, partly on the user's computer, as a stand-alone software package, partly on the user's computer, and partly on a remote computer or entirely on the remote computer or server.

Aspects of the present invention are described in the instant specification with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented on one or more servers for providing a shared playlist, the method comprising:
receiving a plurality of identifiers associated with a plurality of client devices;
receiving a plurality of listening profiles associated with the identifiers;
generating the shared playlist based on the plurality of listening profiles; and
transmitting the shared playlist to the plurality of client devices, wherein the shared playlist is executed on the plurality of client devices in a synchronized manner via one or more application programing interfaces (APIs) provided by one or more third party audio streaming services.

2. The method of claim 1, wherein the plurality of listening profiles is based on a plurality of requests to the one or more third party audio streaming services.

3. The method of claim 2, wherein the plurality of identifiers is based on one or more selections made by a user on a graphical user interface (GUI) of a first client device of the plurality of client devices .

4. The method of claim 3, wherein the one or more selections are based on approximate locations of at least a portion of the plurality of client devices displayed by the GUI.

5. The method of claim 1, wherein generating the shared playlist is further based on machine learning.

6. The method of claim 1, wherein generating the shared playlist is further based on at least one location associated with the plurality of client devices.

7. The method of claim 1, wherein generating the shared playlist is further based on a plurality of locations associated with the plurality of client devices.

8. The method of claim 1, wherein generating the shared playlist is further based on a calendar date.

9. The method of claim 1, wherein generating the shared playlist is further based on a time of day.

10. The method of claim 1, wherein generating the shared playlist is further based on a current event.

11. The method of claim 1, wherein the plurality of listening profiles includes a plurality of listening histories associated with a plurality of users associated with at least a portion of the plurality of client devices.

12. The method of claim 1, wherein the plurality of listening profiles includes a plurality of preferred genres associated with a plurality of users associated with at least a portion of the plurality of client devices.

13. The method of claim 1, wherein the plurality of listening profiles includes a plurality of favorite artists associated with a plurality of users associated with at least a portion of the plurality of client devices.

14. The method of claim 1, wherein the plurality of listening profiles includes a plurality of favorite musical interests associated with a plurality of users associated with at least a portion of the plurality of client devices.

15. The method of claim 1, wherein the plurality of listening profiles includes a plurality of favorite songs associated with a plurality of users associated with at least a portion of the plurality of client devices.

16. The method of claim 1, wherein the plurality of listening profiles includes a plurality of purchasing histories associated with a plurality of users associated with at least a portion of the plurality of client devices.

17. The method of claim 16, wherein the plurality of purchasing histories includes music purchases.

18. The method of claim 1, wherein:
the plurality of listening profiles is based on a plurality of requests via the one or more application programing interfaces (APIs) provided by at least three mutually exclusive third party audio streaming services; and
the shared playlist is executed on the plurality of client devices via one or more APIs provided by the at least three mutually exclusive third party audio streaming services.

19. A server for providing a shared playlist, the server comprising
a memory;
a database; and
a processor configured for:
receiving a plurality of identifiers associated with a plurality of client devices;
receiving a plurality of listening profiles associated with the identifiers;
generating the shared playlist based on the plurality of listening profiles; and
transmitting the shared playlist to the plurality of client devices, wherein the shared playlist is executed on the plurality of client devices in a synchronized manner via one or more application programing interfaces (APIs) provided by one or more third party audio streaming services.

20. A non-transitory computer readable medium comprising a plurality of machine-readable instructions which when executed by one or more processors of a server are adapted to cause the server to perform a method server of providing a shared playlist, the method comprising:
receiving a plurality of identifiers associated with a plurality of client devices;
receiving a plurality of listening profiles associated with the identifiers;
generating a shared playlist based on the plurality of listening profiles; and
transmitting the shared playlist to the plurality of client devices, wherein the shared playlist is executed on the plurality of client devices in a synchronized manner via one or more application programing interfaces (APIs) provided by one or more third party audio streaming services.
